(19) United States
(12) Patent Application Publication
(10) Pub. No.: US 2026/0170146 A1
(43) Pub. Date: Jun. 18, 2026

(54) A Method of Assessing Vulnerability of an AI System and a Framework Thereof

(71) Applicants: Robert Bosch GmbH, Stuttgart (DE); Bosch Global Software Technologies Private Limited, Bangalore (IN)

(72) Inventors: Avinash Amballa, Vizianagaram, Andhrapradesh (IN); Manojkumar Somabhai Parmar, Ahmedabad, Gujarat (IN); Govindarajulu Yuvaraj, Bengaluru, Karnataka (IN)

(21) Appl. No.: 19/128,711

(22) PCT Filed: Nov. 14, 2023
(86) PCT No.: PCT/EP2023/081763

§ 371 Date: May 9, 2025

(30) Foreign Application Priority Data
Nov. 14, 2022 (IN) 202241065034

(51) Int. Cl. G06F 21/57

(52) U.S. Cl. CPC G06F 21/577; G06F 2221/033

(57) ABSTRACT

A method of assessing vulnerability of an AI system and a framework thereof is disclosed. The framework includes an AI system in communication with a processor. The AI system includes an AI Model configured to process timeseries inputs and generate an output. The AI system further includes at least a blocker module configured to modify the output when a batch of input queries are identified as an attack vector. The processor is configured to add a calculated perturbation to a batch of input queries to create adversarial inputs. These adversarial inputs are fed to the AI Model and the output is recorded to assess the vulnerability of the AI system.

The following specification describes and ascertains the nature of this invention and the manner in which it is to be performed.

### FIELD OF THE INVENTION

The present disclosure relates to the field of Artificial Intelligence security. In particular, it proposes a method of assessing vulnerability of an AI system and a framework thereof.

### BACKGROUND OF THE INVENTION

With the advent of data science, data processing and decision-making systems are implemented using artificial intelligence modules. The artificial intelligence modules use different techniques like machine learning, neural networks, deep learning etc. Most of the AI based systems, receive large amounts of data and process the data to train AI models. Trained AI models generate output based on the use cases requested by the user. Typically the AI systems are used in the fields of computer vision, speech recognition, natural language processing, audio recognition, healthcare, autonomous driving, manufacturing, robotics etc. where they process data to generate required output based on certain rules/intelligence acquired through training.

To process the inputs and give a desired output, the AI systems use various models/algorithms which are trained using the training data. Once the AI system is trained using the training data, the AI systems use the models to analyze the real time data and generate appropriate result. The models may be fine-tuned in real-time based on the results. The models in the AI systems form the core of the system. Lots of effort, resources (tangible and intangible), and knowledge goes into developing these models.

It is possible that some adversary may try to tamper/manipulate/evade the model in AI Systems to create incorrect outputs. The adversary may use different techniques to manipulate the output of the model. One of the simplest techniques used by the adversary is where the adversary sends queries to the AI system using his own test data to compute or approximate the gradients through the model. Based on these gradients, the adversary can then manipulate the input in order to manipulate the output of the Model. Another technique is wherein the adversary may manipulate the input data to bring an artificial output. This will cause hardships to the original developer of the AI in the form of business disadvantages, loss of confidential information, loss of lead time spent in development, loss of intellectual properties, loss of future revenues etc. Hence there is a need to identify samples in the test data or generate samples that can efficiently extract internal information about the working of the models and assess the vulnerability of the AI system against those sample-based queries. Hence there is a need to identify such manipulations to assess the vulnerability of the AI system.

There are methods known in the prior arts on the method of attacking an AI System. The prior art WO2021/095984 A1—Apparatus and Method for Retraining Substitute Model for Evasion Attack and Evasion attack Apparatus discloses one such method. The method talks about retraining a substitute model that partially imitates the target model by allowing the target model to misclassify for specific attack data.

### BRIEF DESCRIPTION OF THE ACCOMPANYING DRAWINGS

An embodiment of the invention is described with reference to the following accompanying drawings:

FIG. 1 depicts a framework for validating the defense of an AI system (10);

FIG. 2 illustrates method steps (200) of assessing vulnerability mechanism of the AI system (10);

FIG. 3 illustrates an example of a amplitudinal attack on timeseries AI model (M).

### DETAILED DESCRIPTION OF THE DRAWINGS

It is important to understand some aspects of artificial intelligence (AI) technology and artificial intelligence (AI) based systems or artificial intelligence (AI) system. Some important aspects of the AI technology and AI systems can be explained as follows. Depending on the architecture of the implements AI systems may include many components. One such component is an AI module. An AI module with reference to this disclosure can be explained as a component which runs a model. A model can be defined as reference or an inference set of data, which is use different forms of correlation matrices. Using these models and the data from these models, correlations can be established between different types of data to arrive at some logical understanding of the data. A person skilled in the art would be aware of the different types of AI models such as linear regression, naïve bayes classifier, support vector machine, neural networks and the like. It must be understood that this disclosure is not specific to the type of model being executed in the AI module and can be applied to any AI module irrespective of the AI model being executed. A person skilled in the art will also appreciate that the AI module may be implemented as a set of software instructions, combination of software and hardware or any combination of the same.

Some of the typical tasks performed by AI systems are classification, clustering, regression etc. Majority of classification tasks depend upon labeled datasets; that is, the data sets are labelled manually in order for a neural network to learn the correlation between labels and data. This is known as supervised learning. Some of the typical applications of classifications are: face recognition, object identification, gesture recognition, voice recognition etc. In a regression task, the model is trained based on labeled datasets, where the target labels are numeric values. Some of the typical applications of regressions are: Weather forecasting, Stock price predictions, House price estimation, energy consumption forecasting etc. Clustering or grouping is the detection of similarities in the inputs. The cluster learning techniques do not require labels to detect similarities. Learning without labels is called unsupervised learning. Unlabeled data is the majority of data in the world.

As the AI module forms the core of the AI system, the module needs to be protected against attacks. AI adversarial threats can be largely categorized into-model extraction attacks, inference attacks, evasion attacks, and data poisoning attacks. In poisoning attacks, the adversarial carefully inject crafted data to contaminate the training data which eventually affects the functionality of the AI system. Inference attacks attempt to infer the training data from the corresponding output or other information leaked by the target model. Studies have shown that it is possible to recover training data associated with arbitrary model output. Ability to extract this data further possess data privacy issues. Evasion attacks are the most prevalent kind of attack that may occur during AI system operations. In this method, the attacker works on the AI algorithm's inputs to find small perturbations leading to large modifications of its outputs (e.g., decision errors) which leads to evasion of the AI model.

In Model Extraction Attacks (MEA), the attacker gains information about the model internals through analysis of input, output, and other external information. Stealing such a model reveals the important intellectual properties of the organization and enables the attacker to craft other adversarial attacks such as evasion attacks. This attack is initiated through an attack vector. In the computing technology a vector may be defined as a method in which a malicious code/virus data uses to propagate itself such as to infect a computer, a computer system or a computer network. Similarly, an attack vector is defined a path or means by which a hacker can gain access to a computer or a network in order to deliver a payload or a malicious outcome. A model stealing attack uses a kind of attack vector that can make a digital twin/replica/copy of an AI module.

The attacker typically generates random queries of the size and shape of the input specifications and starts querying the model with these arbitrary queries. This querying produces input-output pairs for random queries and generates a secondary dataset that is inferred from the pre-trained model. The attacker then take this I/O pairs and trains the new model from scratch using this secondary dataset. This is a black box model attack vector where no prior knowledge of original model is required. As the prior information regarding model is available and increasing, attacker moves towards more intelligent attacks.

The attacker chooses relevant dataset at his disposal to extract model more efficiently. Our aim through this disclosure is to identify queries that give the best input/output pair needed to evade the trained model. Once the set of queries in the dataset that can efficiently evade the model are identified, we test the vulnerability of the AI system against those queries.

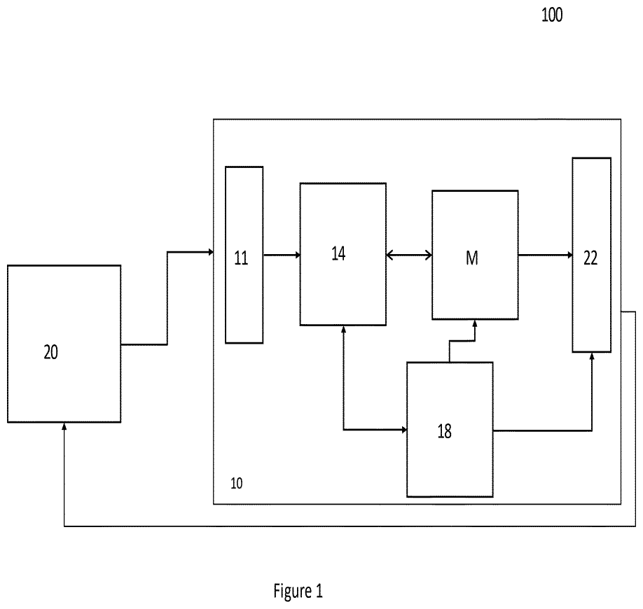

FIG. 1 depicts a framework for assessing vulnerability mechanism of an AI system (10). The framework comprises the AI system that is in communication with a processor. Generally, the processor may be implemented as any or a combination of: one or more microchips or integrated circuits interconnected using a parent board, hardwired logic, software stored by a memory device and executed by a microprocessor, firmware, an application specific integrated circuit (ASIC), and/or a field programmable gate array (FPGA).

The processor is configured to calculate a perturbation to be added to a batch of input queries by means of the processor; add the calculated perturbation to a batch of input queries to create a batch of adversarial inputs; feed the batch of adversarial inputs to an AI model (M) of the AI system (10).

The AI system (10) is configured to configured to process timeseries input queries by means of an AI Model (M) and give an output. A timeseries input refers to a sequence of data points collected over time intervals, allowing us to track changes over a period of time.

The AI system (10) comprises the AI Model (M), submodule (14) and at least a blocker module (18) amongst other components known to a person skilled in the art such as the input interface (11), output interface (22) and the like. For simplicity only components having a bearing on the methodology disclosed in the present invention have been elucidated. The AI system (10) may comprise other components known to person skilled in the art. The submodule (14) is configured to recognize an attack vector from amongst the input queries.

A module with reference to this disclosure refers to a logic circuitry or a set of software programs that respond to and processes logical instructions to get a meaningful result. A hardware module may be implemented in the system as one or more microprocessors, microcomputers, microcontrollers, digital signal submodules, central processing units, state machines, logic circuitries, and/or any component that operates on signals based on operational instructions. The AI system (10) could be a hardware combination of these modules or could be deployed remotely on a cloud or server.

The submodule (14) is configured to identify an attack vector It can be designed or built-in multiple ways to achieve in ultimate functionality of identifying an attack vector from amongst the input. In an embodiment the submodule (14) comprises at least two AI models and a comparator. The said at least two or more models could be any from the group of linear regression, naïve Bayes classifier, support vector machine, neural networks and the like. However at least one of the models is the same as the one executed by the AI Model. For example if the AI Model executes a convolutional neural network (CNN) model, at least one module inside the submodule (14) will also execute the CNN model. The input query is passed through these at least two models and then their result is compared by the comparator to identify an attack vector from amongst the input queries.

In another embodiment of the AI system (10), the submodule (14) additionally comprises a pre-processing block that transposes or modifies the fidelity of input it receives into at least two subsets. These subsets are then fed to the said at least two models and theirs results compared by the comparator. In another embodiment the submodule adds a pre-defined noise to the input data and compares the output of the noisy input and normal input fed to the AI Model (M). Likewise, there are multiple embodiments of the submodule (14) configured to identify an attack vector from amongst the input.

The AI system (10) further comprises at least a blocker module (18) configured to block a user or modify the output when a batch of input queries is determined as an attack vector. In an exemplary embodiment of the present invention, it receives this attack vector identification information from the submodule (14). It is further configured to modify the original output generated by the AI Model (M) on identification of a batch of input queries as attack vector.

It must be understood that the invention in particular discloses methodology used for assessing vulnerability of an AI system (10). While these methodologies describes only a series of steps to accomplish the objectives, these methodologies are implemented in AI system (10), which may be a combination of hardware, software and a combination thereof.

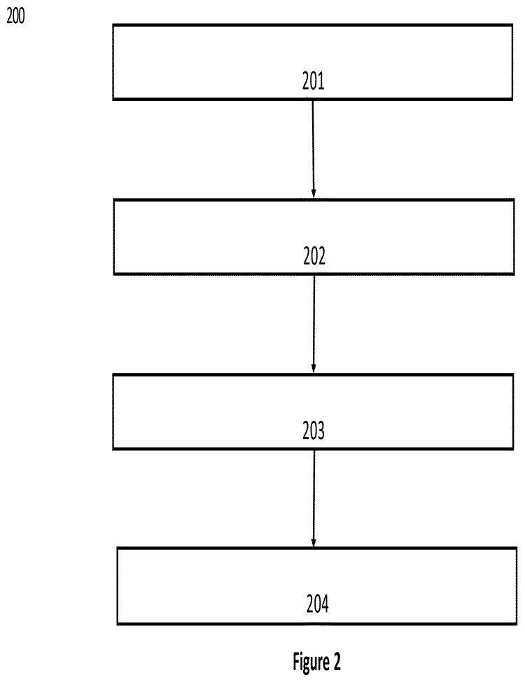

FIG. 2 illustrates method steps for assessing vulnerability of an AI system (10). The AI system (10) and its components have been explained in accordance with FIG. 1. The AI system (10) resides in the framework explained in accordance with FIG. 1.

Method step 201 comprises calculating a perturbation to be added to a batch of input queries by means of the processor (20). The calculation further comprises setting a target function and threshold of output limit. This is followed by calculating the gradient of the AI Model (M) with respect to the batch of input queries, towards the target function. The calculated perturbation causes an amplitudinal limit to be imposed on the output of the AI Model (M).

Method step 202 comprises adding the calculated perturbation to a batch of input queries to create a batch of adversarial inputs.

$$Represented by : {x}_{adv} = {x}_{0} + ∈ * ∇ x ( L ( x , y ) )$$

Where x_{adv} is the adversarial input after calculated perturbation, x₀ is the original input, ∈ is the strength of the attack (amount of perturbation), ∇x is the loss-gradient with respect to the input. Using these method steps the adversarial input is crafted by adding a small amount of perturbation that increases the loss of the true class making the model misclassify the input x_{adv}. Let us understand this with a classification example, wherein the AI model (M) is trained to classify an image into a particular category or class. The perturbation noise is calculated as the gradient of the loss function L with respect to the input image ‘x’ for the given true output class. On the other hand, targeted attacks decrease the loss with respect to the target.

Creating the adversarial inputs can be accomplished using any known attack technique such as Fast Gradient Sign Method (FGSM), Projected Gradient Descent (PGD) and the like. The calculated perturbation causes an amplitudinal limit to be imposed on the output of the AI Model (M).

$$FGSM : {x}_{adv} = {x}_{0} - ∈ * ∇ x ( L ( x , min ( Threshold , y ) ) or {x}_{adv} = {x}_{0} - ∈ * ∇ x ( L ( x , max ( Threshold , y ) )$$

Method step 203 comprises feeding the batch of adversarial inputs to the AI Model (M). In an embodiment of the present invention, the processor (20) is configured to add the calculated perturbation in a specific time window.

Method step 204 recording the output of the AI model (M) to assess the vulnerability of the AI system (10). For a robust defense mechanism of the AI system (10), it is expected that the submodule (14) or the blocker module (18) recognizes the batch of adversarial inputs as attack vectors. Thereafter the blocker module (18) is supposed to block a user or modify the output when a batch of input queries is determined as an attack vector. Hence, while recording the output of the AI system (10), the processor (20) determines percentage and severity of the modified output to assess the vulnerability of the AI system (10).

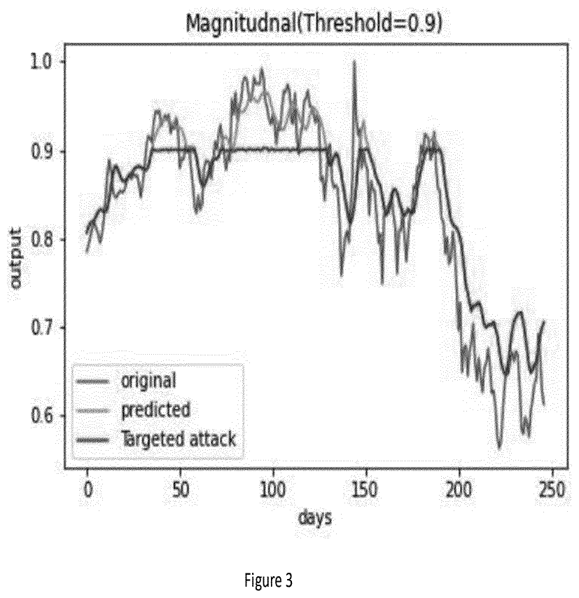

FIG. 3 illustrates an example of an amplitudinal attack on timeseries AI Model (M). As illustrated, a threshold limit of 0.9 is imposed on the output of the AI Model (M). In a real-world example, this example could be of an AI Model (M) trained to predict stock values. The attacker has manipulated the output of the AI Model (M) below the cut-off value of 0.9. The idea of the present invention is to create this adversarial dataset and test the defense of the AI system (10) against this adversarial dataset.

It must be understood that the embodiments explained in the above detailed description are only illustrative and do not limit the scope of this invention. Any modification the framework and adaptation of the method assessing vulnerability of an AI system (10) are envisaged and form a part of this invention. The scope of this invention is limited only by the claims.

1. A method of assessing vulnerability of an AI system, the AI system comprising at least an AI Model and a blocker module, wherein said AI Model is configured to process timeseries input queries and give an output, and the blocker module is configured to modify the output when a batch of input queries are recognized as an attack vector, and wherein said AI system is in communication with a processor, the method comprising:
calculating a perturbation to be added to a batch of input queries by way of the processor;
adding the calculated perturbation to a batch of input queries to create a batch of adversarial inputs;
feeding the batch of adversarial inputs to the AI Model; and
recording the output of the AI Model to assess the vulnerability of the AI system.

2. The method as claimed in claim 1, wherein the calculated perturbation causes an amplitudinal limit to be imposed on the output of the AI Model.

3. The method as claimed in claim 1, wherein calculating the perturbation further comprises:
setting a target function and threshold of output limit; and
calculating a gradient of the AI Model with respect to the batch of input queries, towards the target function.

4. The method as claimed in claim 1, wherein the calculated perturbation is added a specific time window.

5. The method as claimed in claim 1, wherein recording the output of the AI system further comprises determining percentage and severity of the modified output.

6. A framework for assessing vulnerability mechanism of an AI system, the framework comprising: the AI system further comprising at least an AI Model and a blocker module, wherein said AI Model is configured to process a range of input queries and give an output, and the blocker module is configured to modify the output when an input query is recognized as an attack vector; and wherein the framework further comprises:
a processor in communication with the AI module, the processor being configured to:
calculate a perturbation to be added to a batch of input queries by way of the processor;
add the calculated perturbation to a batch of input queries to create a batch of adversarial inputs; and
feed the batch of adversarial inputs to the AI Model.

7. The framework as claimed in claim 6, wherein the calculated perturbation causes an amplitudinal limit to be imposed on the output of the AI Model.

8. The framework as claimed in claim 6, wherein while calculating the perturbation, the processor is further configured to:
set a target function and threshold of output limit; and
calculate a gradient of the AI Model with respect to the batch of input queries, towards the target function.

9. The framework as claimed in claim 6, wherein the calculated perturbation is added a specific time window.

10. The framework as claimed in claim 6, wherein while recording the output of the AI system, the processor determines percentage and severity of the modified output.

11. The framework as claimed in claim 9, wherein the processor is configured to add the calculated perturbation.
